(19) United States
(12) Patent Application Publication
(10) Pub. No.: US 2015/0257342 A1
(43) Pub. Date: Sep. 17, 2015

(54) Hyperbaric Plant Environment

(71) Applicant: Lowell Perry, Wasilla, AK (US)

(72) Inventor: Lowell Perry, Wasilla, AK (US)

(21) Appl. No.: 14/643,116

(22) Filed: Mar. 10, 2015

Related U.S. Application Data
(60) Provisional application No. 61/953,423, filed on Mar. 14, 2014.

(51) Int. Cl. A01G 9/24; A01G 31/00; A01G 13/02; A01G 1/00; A01G 7/00

(52) U.S. Cl. CPC A01G 9/247; A01G 1/001; A01G 7/00; A01G 13/02; A01G 31/00

(57) ABSTRACT

Current technologies which improve plant vitality include increasing dissolved oxygen in water supply and increasing the partial pressure of CO₂. Increasing atmospheric pressure is a simple way to do both. The present invention is a system for maintaining a hyperbaric environment around a plant support system.

### CROSS-REFERENCE TO RELATED APPLICATIONS

This nonprovisional application corresponds to the provisional application 61/953423.

### BACKGROUND OF THE INVENTION

1. Field of the Invention

The present invention is a hyperbaric chamber designed to enclose a life support system for plants, such as a hydroponic system or dirt garden.

2. Description of the Related Art

Current related technologies employed for increasing agricultural production include carbon dioxide (CO₂) supplementation and water oxygenation. Such systems may be overly complicated and expensive and impractical in certain situations. Experiments have been conducted wherein plants have been grown under hypobaric conditions and confirmed that plant growth positively correlates to the partial pressure of CO₂.

### BRIEF SUMMARY OF THE INVENTION

The basic design of the invention is to enclose a plant organism in a pressurized chamber, while providing for the plant's metabolic needs, such as for light, nutrients, water, a substrate, and air exchange, for the purpose of increasing plant vitality.

The first objective of the current invention is to increase the partial pressure of CO₂ gas in the plant environment without the need for concentrated CO₂ dispersement systems.

The second objective is to increase the solubility of oxygen in water without the need for cool temperatures, misting systems, or oxygen concentration systems.

Increasing the atmospheric pressure of the system is a simple way to meet these objectives.

### BRIEF DESCRIPTION OF THE SEVERAL VIEWS OF THE DRAWING

FIG. 1: Diagram of the system. The pressurized environment 20 may be a system of pipes, a reinforced fabric structure, a reinforced solid structure or other structure capable of maintaining a constant pressure and air change rate. The plant support system 28 may be in any form currently such as aquaponic, aeroponic, hydroponic or soil based, or it may take a form not yet in existence. The plant 18 may be any type of photosynthesis based organism.

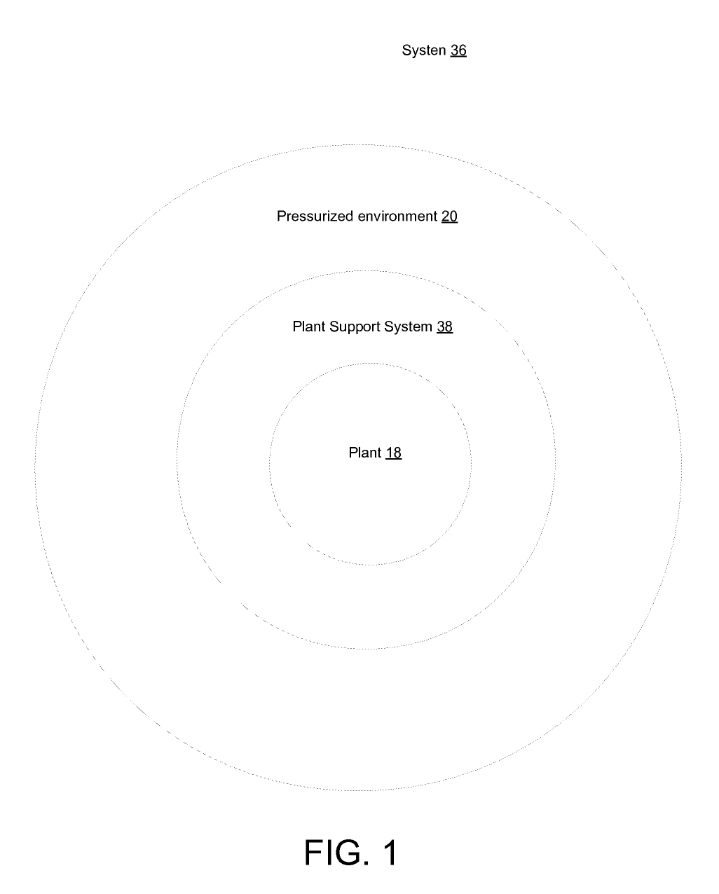

FIG. 2: Side view of preferred embodiment of the system.

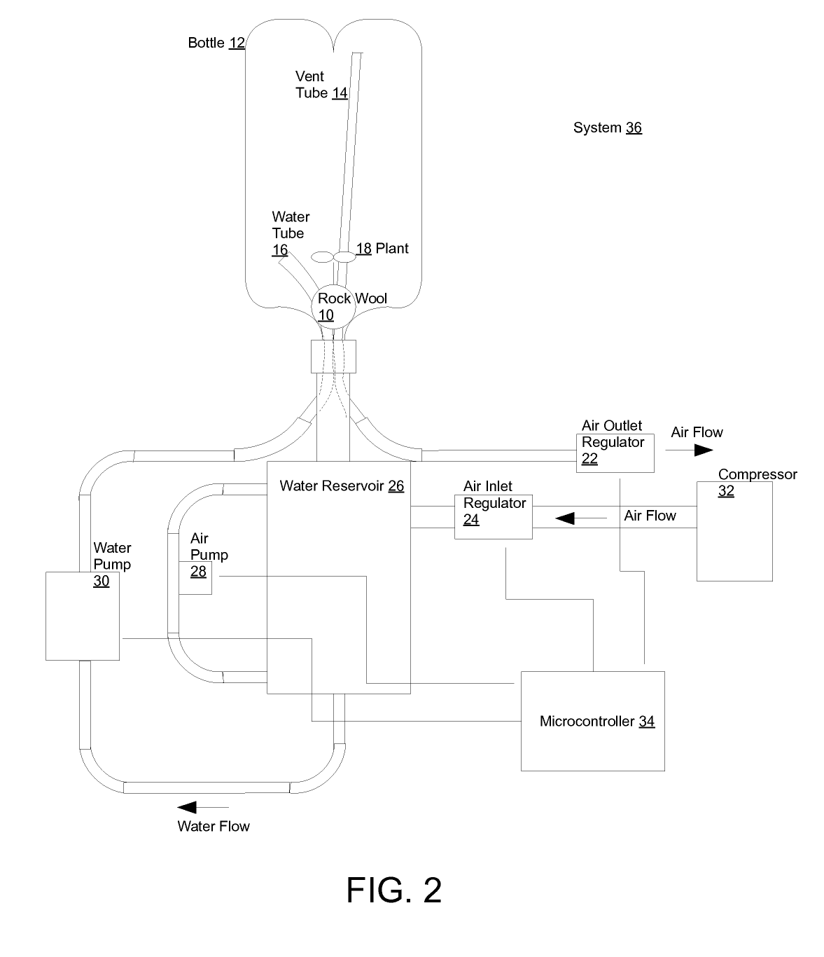

### DETAILED DESCRIPTION OF THE INVENTION

The current invention relates to providing a pressurized, or hyperbaric, environment for plants to grow in. The benefits of hyperbaric pressure include increased partial pressure of CO₂ and increased oxygenation of water, both of which have been shown to be beneficial for plant metabolism. Although an embodiment of this invention could include importation of concentrated CO₂, it is not necessary to achieve increased partial pressure, as increasing the pressure of normal atmosphere alone would increase the partial pressure of CO₂. The higher atmospheric pressure also increased the solubility of oxygen in water, as could be seen by applying Henry's Law to the Van't Hoff equation. Research conducted by the inventor has shown that under application of 15 psig of atmospheric pressure, there is a minimum of a 25% increase in seed germination and 233% increase in growth rate.

Currently, hyperbaric chambers exist for use by humans, but these would be poorly suited and uneconomical for agricultural use. This invention is designed for application of mild pressures on the order of 1 ATA, about 15 psig, as high pressures may have a damaging effect.

The system 36 must be spacious enough to allow for plant growth for the duration of time that the plant(s) is/are intended to be contained in the system 36. The system 36 must provide sufficient light for the plant, artificial or natural. There must be a plant life support system 38, which would include means 16, 26, 30, 34 of watering the plant and fertilizing the plant while it is growing in the pressurized environment 20, although this means may include depressurizing the environment 20 and manually applying water or nutrient solution. The environment 20 must include a substrate 10 for the plants to grow in. Additionally, there must be a means 14, 22, 24, 32, 34, for removal of plant respiratory byproducts, e.g. Ethylene, the build-up of which has a negative effect on plant growth. Ideally, the environment 20 would include an air pump 28 to oxygenate the water source to take full advantage of the increased solubility of oxygen.

A simple embodiment of this invention would be to put a kit home hydroponic system 38 and grow light inside a medical flow through type hyperbaric chamber 20. However, such a system would most likely not be cost effective.

The embodiment for this invention 36 would vary depending on the species of plants grown and for what period of their development.

The preferred embodiment would be a system of pipes 36 pressurized with a compressor 32 controlled by a pressure regulator 24. Recycled soda bottles 12 could be attached to the system to provide individual plant growth chambers transparent to natural light. The system would allow for watering 16, 26, 30 and ventilation 14, 22, 24, 32 via manual control or an electronic automation device 34. Seeds could be planted in rock-wool 10 in the bottles 12 and grown until they run out of space, at which point they would be harvested as micro-greens or transplanted to another growing system. To remove the plants 18, the bottles 12 would be cut open. If further plant growth is desired, transparent pipe in large diameter is available and could be attached to the system in place of the soda bottles.

A chamber for fish could be included in the system, as is done in some current, unpressurized plant support systems, which are described by the term aquaponic. The increased oxygenation of the water would benefit fish in theory, although experimentation by the inventor has not confirmed this.

A small system as just described would be beneficial in colder climates, such as Canada, or northern Europe, where agriculturalists commonly start growing plants in winter under artificial lighting for transplant to green houses in the Spring. This system, by increasing growth rate of plants, would cut costs dramatically.

Another embodiment of the system would be to utilize a reinforced green house, capable of withstanding the applicable pressures for the environment 20. Transparent vinyl reinforced by a mesh of basalt fiber and rooted in a concrete footing could be a possible construction design. This could allow for the growth of larger plants, but would increase the complexity. An air lock would likely be necessary, as well as a pressure-safe transversal of the environment boundary by utilities including electricity and water. Such a system would be ideal for temperate weather, as it would make use of natural light, but would have little thermal insulation.

A thermally insulated version of the pressurized environment 20 would likely need to have artificial light. It could be made from metal or reinforced concrete and likely need to be spherical or semi-spherical in shape. It could be buried under ground for further reinforcement and insulation. Such a system would be effective in the most extreme environments, such as Arctic regions, Space or other extraterrestrial locations.

1. The present invention includes a system for maintaining a constant level of atmospheric pressure above 1 atmosphere.

2. The present invention includes a system for maintaining the growth of plants which includes provision of light, water, nutrients, substrate, ventilation and space.
